(19) United States
(12) Patent Application Publication
(10) Pub. No.: US 2010/0211501 A1
(43) Pub. Date: Aug. 19, 2010

(54) ELECTRONIC SETTLEMENT APPARATUS ANS CONTROL METHOD FOR THE APPARATUS

(75) Inventor: Yuichi Ogawa, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/695,492

(22) Filed: Jan. 28, 2010

(30) Foreign Application Priority Data
Feb. 13, 2009 (JP) 2009-031474

(51) Int. Cl. G06Q 20/00; G06Q 40/00; G06F 3/033; G06F 3/048

(52) U.S. Cl. 705/41; 715/863; 715/840; 345/173

(57) ABSTRACT

A balance of an electronic money detected by a detection unit is specified. An order of priority for each electronic money is set on the basis of the specified balance of the electronic money. A screen in which information about each electronic money is arranged in accordance with the set order of priority is displayed on a display unit. An electronic money to be used for settlement of a transaction is selected from electronic moneys specified on the basis of the information displayed on the screen. The transaction is settled using the selected electronic money.

### CROSS-REFERENCE TO RELATED APPLICATION

This application is based upon and claims the benefit of priority from the prior Japanese Patent Application No. 2009-031474, filed Feb. 13, 2009, the entire contents of which are incorporated herein by reference.

### TECHNICAL FIELD

The present invention relates to an electronic settlement apparatus having a function of settling the payment of a transaction price with electronic money, and a control method for the apparatus.

### BACKGROUND

Recently, a settlement system using electronic money is becoming popular. Following this trend, various inventions are made with respect to settlement using electronic money.

For example, in a settlement apparatus disclosed in JP-A-2008-9748, if information about plural electronic money brands is read out from a storage medium that stores information about electronic moneys, the order of priority for each brand is decided on the basis of transaction history and information about the brands is displayed in accordance with the decided order of priority. Then, settlement is executed with a brand selected from the displayed content.

If information about plural electronic money brands is stored in a storage medium as described above, it is possible that a brand with an electronic money balance lower than the price is included in the information. However, with conventional settlement apparatuses including the settlement apparatus disclosed in JP-A-2008-9748, a customer cannot recognize the electronic money balance and then select an electronic money brand to be used for settlement.

Therefore, if an electronic money brand with an insufficient balance is selected, processing to select an additional electronic money brand to pay the remaining price or processing to cancel the initial selection and select another electronic money brand again is needed. If such processing is adopted, settlement is delayed and it is probable that customers waiting for payment have to wait for a long time. Moreover, the number of points given in a transaction is different among electronic money brands to be used. This difference is a factor that makes it time-consuming to select an electronic money.

### SUMMARY

In view of the foregoing circumstances, it is an object of the invention to provide an electronic settlement apparatus which enables a customer to easily select an electronic money to be used and carry out settlement smoothly, and a control method for the apparatus.

An electronic settlement apparatus according to an aspect of the invention includes: a display unit which selectively displays various kinds of information; a detection unit which detects, from an electronic money medium storing plural kinds of electronic money, the electronic money; a balance specifying unit which specifies a balance of the electronic money detected by the detection unit; a priority order setting unit which sets an order of priority for each electronic money on the basis of the balance of the electronic money specified by the balance specifying unit; a display control unit which causes the display unit to display a screen in which information about each electronic money is arranged in accordance with the order of priority set by the priority order setting unit; a selection unit which selects an electronic money to be used for settlement of a transaction, from electronic moneys specified on the basis of the information displayed on the screen; and an electronic money settlement unit which settles a transaction using the electronic money selected by the selection unit.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of essential parts of an electronic settlement apparatus according to an embodiment of the invention.

FIG. 2 is a schematic view showing the data structure of electronic money information in the embodiment.

FIG. 3 is a flowchart showing processing executed by a CPU of the electronic settlement apparatus in the embodiment.

FIG. 4 shows an example of a brand selection screen in the embodiment.

FIG. 5 is another example of the brand selection screen in the embodiment.

### DETAILED DESCRIPTION

Hereinafter, an embodiment of the invention will be described with reference to the drawings.

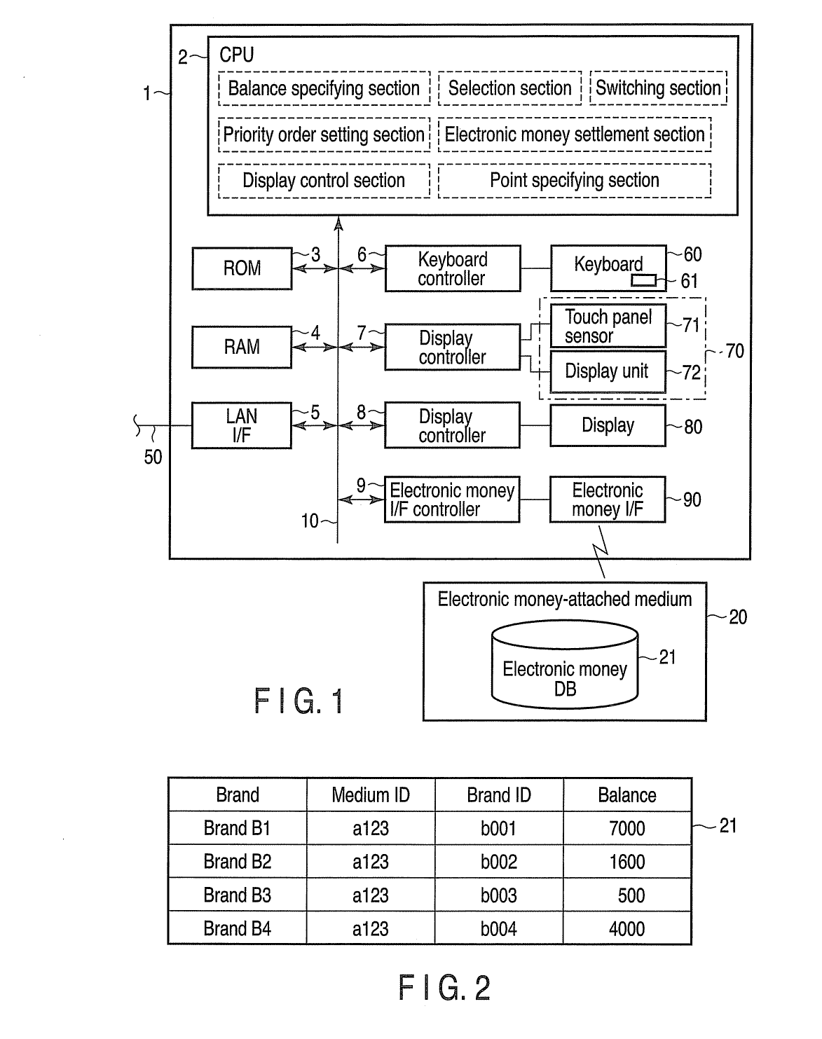

FIG. 1 is a block diagram showing the configuration of essential parts of an electronic settlement apparatus 1 according to an embodiment of the invention. The electronic settlement apparatus 1 has a CPU (central processing unit) 2 functioning as the center of control. To this CPU 2, a ROM (read only memory) 3, a RAM (random access memory) 4, a communication I/F (interface) 5, a keyboard controller 6, a customer-side display controller 7, a display controller 8, an electronic money I/F controller 9 and so on are connected via a bus line 10. A LAN (local area network) cable 50 is connected to the communication I/F 5. A keyboard 60 is connected to the keyboard controller 6. A touch panel sensor 71 and a display unit 72 of a customer-side display 70 are connected to the customer-side display controller 7. A cashier-side display 80 is connected to the display controller 8. An electronic money I/F 90 is connected to the electronic money I/F controller 9.

The communication I/F 5 controls communication with a network such as the Internet connected via the LAN cable 50. The keyboard controller 6 takes in a signal corresponding to an operation key outputted from the keyboard 60 and notifies the CPU 2 of the signal that is taken in. The keyboard 60 is provided with numeric keys and an electronic money key 61 or the like that declares payment of a price using electronic money.

The customer-side display controller 7 controls the display unit 72 to selectively display various kinds of information. The customer-side display controller 7 takes in an electric signal outputted from the touch panel sensor 71, then calculates the coordinates of a touch-operated position on the basis of the electric signal that is taken in, and notifies the CPU 2 of the calculated coordinates. The customer-side display 70 is provided in the body of the electronic settlement apparatus 1, with its display side facing the position where the customer stands.

The display controller 8 controls the screen display of the display 80. The electronic money I/F controller 9 functions as a detection unit in this embodiment and controls wireless communication between the electronic money I/F 90 and an electronic money-attached medium 20 held by the customer.

The electronic money-attached medium 20 has an electronic money DB (database) 21 in a storage unit provided inside. FIG. 2 is a schematic view showing the data structure of the electronic money DB 21. The electronic money DB 21 includes electronic money information of plural kinds of electronic moneys (hereinafter referred to as brands) issued from difference sources. A medium ID as a univocal identifier allocated to the electronic money-attached medium 20, a brand ID as a univocal identifier allocated to each brand, and a electronic money balance in each brand are associated with each electronic money information. In this embodiment, the electronic money DB 21 includes electronic money information of brands B1 to 84. The electronic money balance of the brands 81 to 84 is “7,000” yen, “1,600” yen, “500” yen, and “4,000” yen, respectively.

The CPU 2 has the following sections (1) to (7) to realize characteristic functions in this embodiment.

(1) A balance specifying section which specifies the electronic money balance detected from the electronic money-attached medium 20 via the electronic money I/F 90.

(2) A point specifying section which specifies the order of each electronic money with respect to points given for the use of the electronic money detected from the electronic money-attached medium 20 via the electronic money I/F 90. Particularly, this section specifies the order with respect to the amount of points given for the use of each electronic money when the electronic money is used.

(3) A priority order setting section which sets the order of priority of each electronic money on the basis of the electronic money balance specified by the balance specifying section or the order of each electronic money specified by the point specifying section.

(4) A display control section which causes the display unit 72 to display a screen in which information about each electronic money is arranged in accordance with the order of priority set by the priority order setting section. The information about each electronic money is a brand image of each electronic money or the like. Moreover, this section display the brand images so that an electronic money with a balance lower than the price of a transaction can be identified, and this section changes the color of the brand images in accordance with the balance of each electronic money.

(5) A switching section which switches the screen displayed on the display unit 72 by the display control section in accordance with one of the order of priority based on the electronic money balance and the order of priority set on the basis of the order with respect to points, to the screen in which information about each electronic money is arranged in accordance with the other one of these orders of priority.

(6) A selection section which selects an electronic money to be used for settlement of a transaction, from electronic moneys specified on the basis of the information displayed on the display unit 72.

(7) An electronic money settlement section which settles a transaction using the electronic money selected by the selection section.

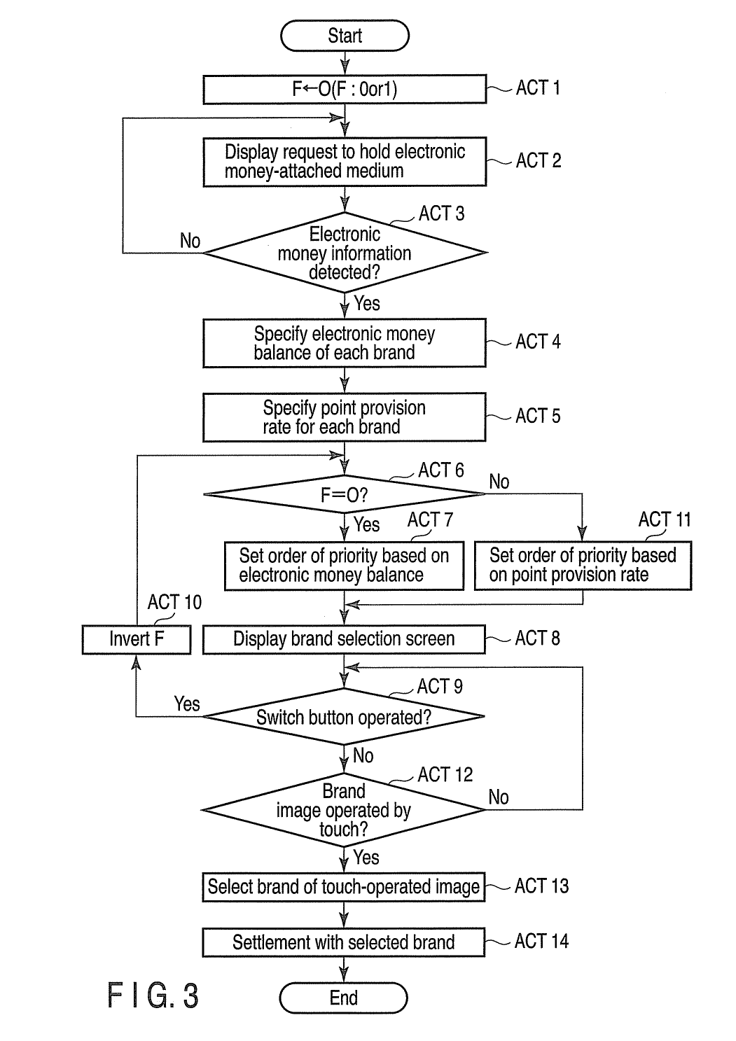

Next, the operation of the electronic settlement apparatus 1 having the configuration as described above will be described. FIG. 3 is a flowchart showing the operation of the CPU 2 at the time of paying the price of a transaction with electronic money in an accounting process using the electronic settlement apparatus 1. This processing is started in response to the operation of the electronic money key 61 by the cashier after sale data of an article to be purchased by a customer is registered to the electronic settlement apparatus 1.

First, the CPU 2 forms a flag F in the RAM 4 and initializes its value to “0” (ACT 1). Next, the CPU 2 causes the display unit 72 to display a message prompting the customer to hold the electronic money-attached medium 20 over the electronic money I/F 90 (ACT 2). The CPU 2 then shifts to a state of waiting for reception of the electronic money DB 21 from the electronic money-attached medium 20 (ACT 3). If the customer holds the electronic money-attached medium 20 over the electronic money I/F 90 in the state where the electronic settlement apparatus 1 is waiting for reception of the electronic money DB 21 in this manner, the electronic money I/F 90 detects the electronic money DB 21 from the electronic money-attached medium 20 (Yes in ACT 3). The CPU 2 stores the electronic money DB 21 detected by the electronic money I/F 90, in the RAM 4.

Next, on the basis of the electronic money DB 21 stored in the RAM 4, the CPU 2 specifies the electronic money balance of each brand stored in the electronic money DB 21 (ACT 4). Moreover, the CPU 2 communicates with the server of the service provider of the electronic money brand specified by the brand ID of each brand via the communication I/F 5 and specifies the point provision rate (ACT 5). The point provision rate refers to a numeric value indicating what percentage of the price is returned to the customer as points. In this embodiment, for example, the point provision rates of 5% for the brand B1, 1% for the brand B2, 8% for the brand B3 and 10% for the brand 54 are specified.

Next, the CPU 2 determines whether the value of the flag F is “0” (ACT 6). At this time, if the value of the flag F is “0” (Yes in ACT 6), an order of priority is set for the electronic money information of each brand in descending order of the electronic money balance (ACT 7). For example, if an order of priority is set for the electronic money information constituting the electronic money DB 21 shown in FIG. 2, priorities 1 to 4 are given to electronic money information of the brand B1, brand 34, brand B2 and brand 33 in order.

After setting the order of priority for each electronic money information, the CPU 2 causes the display unit 72 to display a brand selection screen 100 in which a brand image of each electronic money information is arranged according to the order of priority (ACT 8). In this embodiment, electronic money balances are classified into three sections of 5,000 yen or more (section 1), less than 5,000 yen and 2,000 yen or more (section 2), and less than 2,000 yen (section 3). The color of each brand image is changed according to the section which its balance belongs to. Moreover, a brand with its electronic money balance lower than the price is displayed in a manner that this brand can be distinguished from other brands.

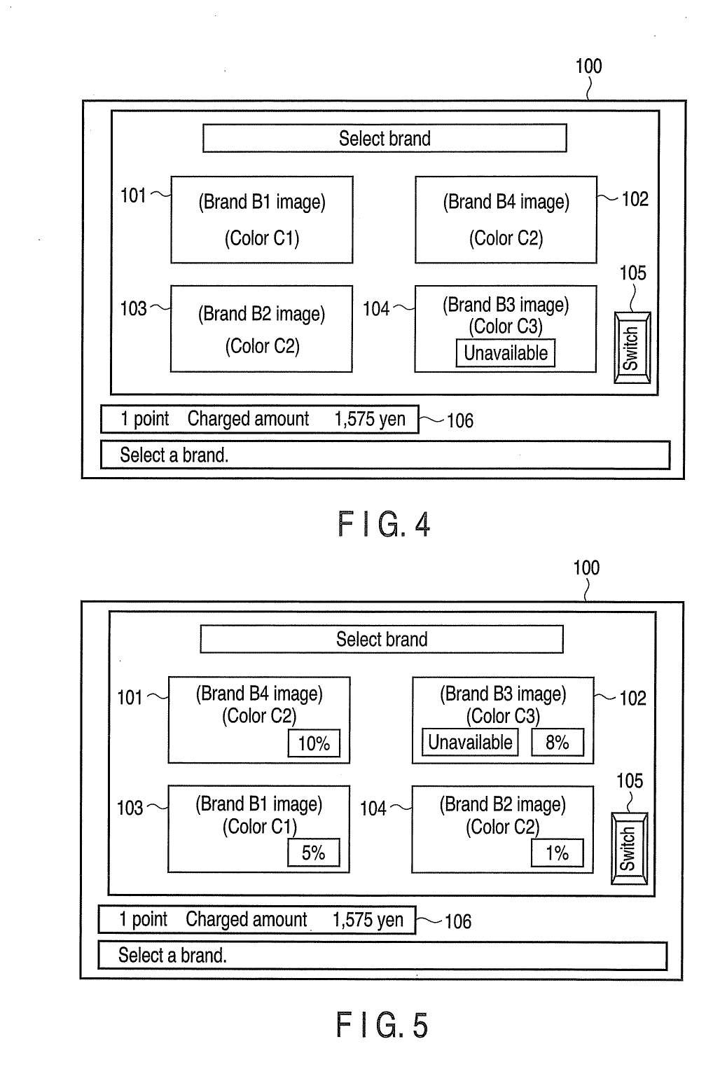

FIG. 4 shows an example of the brand selection screen 100. In the brand selection screen 100, display sections 101 to 104 showing brand images of the electronic money information with priorities 1 to 4, a switch button 105, and an amount display section 106 as a price display section are arranged. The user can operate the display sections 101 to 104 and the switch button 105 by touching the touch panel sensor 71 with a fingertip or touch pen. In the display sections 101 to 104, brand images of the brand B1, brand B4, brand B2 and brand B3 are displayed in order according to the order of priority set by the processing of ACT 7. The brand images displayed in the display sections 101 to 104 are classified by color in a manner that the brand image of the electronic money information belonging to the section 1 is in a color C1, the brand image of the electronic money information belonging to the section 2 is in a color C2, and the brand image of the electronic money information belonging to the section 3 is in a color C3. That is, the electronic money balance of the brand B1 belongs to the section 1 and therefore its brand image is displayed in the color C1. The electronic money balance of the brand B4 belongs to the section 2 and therefore its brand image is displayed in the color C2. The electronic money balances of the brands B2 and B3 belong to the section 3 and therefore their brand images are displayed in the color C3. Meanwhile, the electronic money balance of the brand B3 is lower than the price of 1,575 yen. Therefore, an indication of “unavailable” is added to the brand image of the brand B3 in order to notify the user of the insufficiency of balance.

After displaying the brand selection screen 100 on the display unit 72, the CPU 2 determines whether the switch button 105 is operated by touch (ACT 9). When the switch button 105 is operated by touch (Yes in ACT 9), the CPU 2 inverts the value of the flag F, that is, to “1” if the value is currently “0”, and to “0” if the value is currently “1” (ACT 10). Then, the CPU 2 returns to the operation of ACT 6 again and determines whether the value of the flag F is “0”. At this time, if the value of the flag F is not “0” (No in ACT 6), the CPU 2 sets an order of priority in descending order of the point provision rate (ACT 11). For example, if an order of priority is set on the basis of the point provision rate of each of the above electronic money brands, priorities 1 to 4 are given to the brand B4, brand B3, brand B1 and brand B2 in order. After setting the order of priority based on the point provision rate in this manner, the CPU 2 causes the display unit 72 to display the brand selection screen 100 in which brand images are arranged according to this order of priority.

FIG. 5 shows an example of the brand selection screen 100 in which brand images are arranged according to the order of priority set on the basis of the point provision rate. Brand images of the brand B4, brand B3, brand B1 and brand B2 are displayed in the display sections 101 to 104 in accordance with the order of priority set in the operation of ACT 11. The point provision rate is also displayed together with each brand image. The brand images are classified by color, as described above with reference to FIG. 4. For a brand having a balance lower than the price, an indication of unavailability is added.

If it is determined that the switch button 105 is not operated in the operation of ACT 9 (No in ACT 9), the CPU 2 determines whether one of the brand images is operated by touch (ACT 12). The CPU 2 continues this determination until the switch button 105 or one of the brand images is operated by touch (No in ACT 12). By the way, if a brand image with an indication of unavailability is operated by touch, the CPU 2 processes the selection as invalid.

When a brand image with no indication of unavailability shown in the display sections 101 to 104 is operated by touch by the customer (Yes in ACT 12), the CPU 2 selects the electronic money indicated by the brand image that is operated by touch, as the electronic money to execute settlement with (ACT 13). Then, the CPU 2 executes settlement using the selected electronic money (ACT 14). Specifically, the CPU 2 subtracts the price of the transaction from the balance of the electronic money selected in the operation of ACT 13, thus calculates a new balance of the electronic money, and sends the calculated balance and the brand ID of the electronic money to the electronic money-attached medium 20 via the electronic money I/F 90. As the electronic money-attached medium 20 receives the balance of the electronic money and the brand ID of the electronic money sent from the electronic settlement apparatus 1, the electronic money-attached medium 20 updates the balance stored in the electronic money DB 21 in association with the received brand ID, with the received balance. The CPU 2 also sends the number of points obtained by multiplying the price of the transaction by the point provision rate for this brand to the server of the service provider of the brand via the communication I/F 5. Moreover, the CPU 2 performs known processing of settlement and ends the electronic money settlement.

As described above, in the electronic settlement apparatus 1, brand images displayed in the brand selection screen 100 are rearranged according to the balance of electronic money. Therefore, the customer can select a brand displayed at a high-order position with a high electronic money balance and therefore can avoid redundant processing such as re-selection of a brand due to insufficiency in balance or parallel use of electronic money settlement and cash settlement. Thus, settlement smoothly proceeds.

Also, brand images displayed in the brand selection screen 100 are displayed in a manner that enables identification as to whether the electronic money of each brand has a balance equal to or higher than the price of a transaction or not. Therefore, the customer can instantly recognize a brand with an insufficient balance. Moreover, instead of displaying the electronic money balance on the customer-side display 70, the color of brand images is changed or an indication of unavailability is added so that the customer can indirectly recognize the balance. Therefore, the balance of electronic money is not known to a third party.

By operating the switch button 105, the customer can also switch between the display of brand images according to the order of electronic money balance and the display of brand images according to the order of point provision rate. Therefore, the customer can pay the price using a brand that is convenient for the user, with reference to the number of points given, the balance and so on.

In the above embodiment, the case of classifying brand images by color in the display to enable identification of the balance is described. However, identification of the balance may also be enabled by other techniques such as adding a symbol according to the balance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic settlement apparatus comprising:
a display unit which selectively displays various kinds of information;
a detection unit which detects, from an electronic money medium storing plural kinds of electronic money, the electronic money;
a balance specifying unit which specifies a balance of the electronic money detected by the detection unit;
a priority order setting unit which sets an order of priority for each electronic money on the basis of the balance of the electronic money specified by the balance specifying unit;
a display control unit which causes the display unit to display a screen in which information about each electronic money is arranged in accordance with the order of priority set by the priority order setting unit;
a selection unit which selects an electronic money to be used for settlement of a transaction, from electronic moneys specified on the basis of the information displayed on the screen; and
an electronic money settlement unit which settles the transaction using the electronic money selected by the selection unit.

2. The apparatus according to claim 1, wherein the display control unit causes the display unit to display information about each electronic money in accordance with the order of priority set by the priority order setting unit and in such a manner that an electronic money having an electronic money balance lower than a price of a transaction can be identified.

3. The apparatus according to claim 1, wherein the display control unit causes the display unit to display information about each electronic money in accordance with the order of priority set by the priority order setting unit and by changing color according to the balance of the electronic money.

4. The apparatus according to claim 1, further comprising a touch panel arranged on a front side of the display unit,
wherein the display control unit causes the display unit to display a screen in which an image about each electronic money is arranged in accordance with the order of priority set by the priority order setting unit, and in response to detection of a touch operation of an image of an electronic money displayed in the screen of the display unit via the touch panel, the selection unit selects an electronic money specified by the touch-operated image as an electronic money to be used for settlement of a transaction.

5. An electronic settlement apparatus comprising:
a display unit which selectively displays various kinds of information;
a detection unit which detects, from an electronic money medium storing plural kinds of electronic money, the electronic money;
a balance specifying unit which specifies a balance of the electronic money detected by the detection unit;
a point specifying unit which specifies an order of each electronic money with respect to a point given for use of the electronic money detected by the detection unit;
a first priority order setting unit which sets an order of priority for each electronic money on the basis of the balance of the electronic money specified by the balance specifying unit;
a second priority order setting unit which sets an order of priority for each electronic money on the basis of the order of each electronic money specified by the point specifying unit;
a display control unit which causes the display unit to display a screen in which information about each electronic money is arranged in accordance with the order of priority set by one of the first priority order setting unit and the second priority order setting unit;
a switching unit which switches the screen that the display control unit causes the display unit to display in accordance with the order of priority set by one of the first priority order setting unit and the second priority order setting unit, to a screen in which information about each electronic money is arranged in accordance with the order of priority set by the other priority order setting unit;
a selection unit which selects an electronic money to be used for settlement of a transaction, from electronic moneys specified on the basis of the information displayed on the screen; and
an electronic money settlement unit which settles the transaction using the electronic money selected by the selection unit.

6. The apparatus according to claim 5, further comprising a touch panel arranged on a front side of the display unit,
wherein a switch button that can be touch-operated via the touch panel is displayed on the display unit, and in response to detection of a touch operation of the switch button via the touch panel, the switching unit switches the screen displayed by the display unit in accordance with the order of priority set by one of the first priority order setting unit and the second priority order setting unit, to the screen in which information about each electronic money is arranged in accordance with the order of priority set by the other priority order setting unit.

7. The apparatus according to claim 5, wherein the display control unit causes the display unit to display information about each electronic money in accordance with the order of priority set by one of the first priority order setting unit and the second priority order setting unit and in such a manner that an electronic money having an electronic money balance lower than a price of a transaction can be identified.

8. The apparatus according to claim 5, wherein the display control unit causes the display unit to display information about each electronic money in accordance with the order of priority set by one of the first priority order setting unit and the second priority order setting unit and by changing color according to the balance of the electronic money.

9. The apparatus according to claim 5, further comprising a touch panel arranged on a front side of the display unit,
wherein the display control unit causes the display unit to display a screen in which an image about each electronic money is arranged in accordance with the order of priority set by one of the first priority order setting unit and the second priority order setting unit, and in response to detection of a touch operation of an image of an electronic money displayed in the screen of the display unit via the touch panel, the selection unit selects an electronic money specified by the touch-operated image as an electronic money to be used for settlement of a transaction.

10. A control method for an electronic settlement apparatus including a display unit which selectively displays various kinds of information and a detection unit which detects, from an electronic money medium storing plural kinds of electronic money, the electronic money, the method comprising:
detecting the electronic money by the detection unit;
specifying a balance of the electronic money detected by the detection unit;
setting an order of priority for each electronic money on the basis of the specified balance of the electronic money;
causing the display unit to display a screen in which information about each electronic money is arranged in accordance with the set order of priority;
selecting an electronic money to be used for settlement of a transaction, from electronic moneys specified on the basis of the information displayed on the screen; and
settling the transaction using the selected electronic money.
